(19) United States
(12) Patent Application Publication
(10) Pub. No.: US 2023/0063503 A1
(43) Pub. Date: Mar. 2, 2023

(54) EVENT-BASED CALENDAR ENTRY NOTIFICATIONS

(71) Applicant: INTERNATIONAL BUSINESS MACHINES CORPORATION, ARMONK, NY (US)

(72) Inventors: ROBERT KERR, Cambridge (GB); MICHAEL KIRWAN, Cambridge (GB); Mark J Bingley, Huntingdon (GB); Ian Philip Kitchen, Bishops Storford (GB)

(21) Appl. No.: 17/446,720

(22) Filed: Sep. 2, 2021

(51) Int. Cl. G06Q 10/10; H04L 29/08

(52) U.S. Cl. CPC G06Q 10/1093; H04L 67/26; H04L 67/306

(57) ABSTRACT

A computer-implemented method, a computer system and a computer program product are described for event-based calendar entry notifications. The method includes providing a plurality of event categories for classifying at least one event of a calendar entry. The method also includes generating a notification profile for each of the plurality of event categories based on a notification parameter used in a previous calendar entry. Lastly, the method includes applying the notification profile to an event of a new calendar entry by matching the event category of the event of the new calendar entry to an event category and using the notification profile applied to the event category.

### BACKGROUND

Embodiments of the present invention relate to calendar systems, and more specifically, to entry notifications in calendar systems.

Personal and business calendar and scheduling applications may allow users to create entries quickly that represent planned events. These applications may have supporting features such as invitees, location, description, recurrence, and notifications. In the interest of streamlining the entry creation flow, default settings and accelerators may be applied where possible.

While it may be possible to apply default notification settings, it may be unlikely that a blanket setting will be appropriate for all types of event. For example, a user might want to be reminded 2-3 days in advance of a weekend away in order to ensure they are prepared, while a suitable reminder about an evening out might be 1-2 hours.

### SUMMARY

An embodiment is directed to a computer-implemented method for event-based calendar entry notifications. The method may include providing a plurality of event categories for classifying at least one event of a calendar entry. The method may also include generating a notification profile for each of the plurality of event categories based on a notification parameter used in a previous calendar entry. Lastly, the method may include applying the notification profile to an event of a new calendar entry by matching the event category of the event of the new calendar entry to an event category and using the notification profile applied to the event category.

According to another embodiment, there is provided a computer system for event-based calendar entry notifications, comprising: one or more processors, one or more computer-readable memories, one or more computer-readable tangible storage media, and program instructions stored on at least one of the one or more tangible storage media for execution by at least one of the one or more processors via at least one of the one or more memories. The computer system may be capable of performing a method that may include providing a plurality of event categories for classifying at least one event of a calendar entry. The method may also include generating a notification profile for each of the plurality of event categories based on a notification parameter used in a previous calendar entry. Lastly, the method may include applying the notification profile to an event of a new calendar entry by matching the event category of the event of the new calendar entry to an event category and using the notification profile applied to the event category.

According to a further embodiment, there is provided a computer program product for event-based calendar entry notifications, the computer program product comprising a computer readable storage medium having program instructions embodied therewith, the program instructions executable by a processor to cause the processor to provide a plurality of event categories for classifying at least one event of a calendar entry. The processor may also generate a notification profile for each of the plurality of event categories based on a notification parameter used in a previous calendar entry. Lastly, the processor may apply the notification profile to an event of a new calendar entry by matching the event category of the event of the new calendar entry to an event category and using the notification profile applied to the event category.

The computer readable storage medium may be a non-transitory computer readable storage medium and the computer readable program code may be executable by a processing circuit.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings.

Preferred embodiments of the present invention will now be described, by way of example only, with reference to the following drawings in which:

FIG. 1 is a flow diagram of an example embodiment of a method in accordance with the present invention;

FIG. 2 is a flow diagram of another example embodiment of an aspect of a method in accordance with the present invention;

FIG. 3 is a flow diagram of a further example embodiment of an aspect of a method in accordance with the present invention;

FIG. 4 is block diagram of an example embodiment of a system in accordance with the present invention;

FIG. 5 is a block diagram of an embodiment of a computer system or cloud server in which the present invention may be implemented;

FIG. 6 is a schematic diagram of a cloud computing environment in which the present invention may be implemented; and

FIG. 7 is a diagram of abstraction model layers of a cloud computing environment in which the present invention may be implemented.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

A method and system are provided for event-based calendar entry notifications. A notification profile is generated and applied for each categorized type of event based on previous calendar entry notification parameters. The notification parameters may include a number of a series of notifications leading up to an event of a calendar entry and a timing of the notifications in a series.

Automated notification settings for a user or group of users may be based on a generated notification profile for events of the same type. The generated notification profile may be based on previous calendar entries and may be dynamically updated based on additional calendar entries with. The generated notification profile may determine the best default notification settings for the types of events based on the user's notification preferences. There may be an option for a user to override the automated notification settings which may result in updating of the notification profile.

The method may include analyzing types of events scheduled in previous calendar entries to build a notification profile of a user's notification preferences. The analysis of the types of events may build an automated classifier for events.

Notifications regarding real-world events require an appropriate lead time for the planning or preparation of the event. The described method and system infer appropriate notification parameters from historical user activity around similar calendar events.

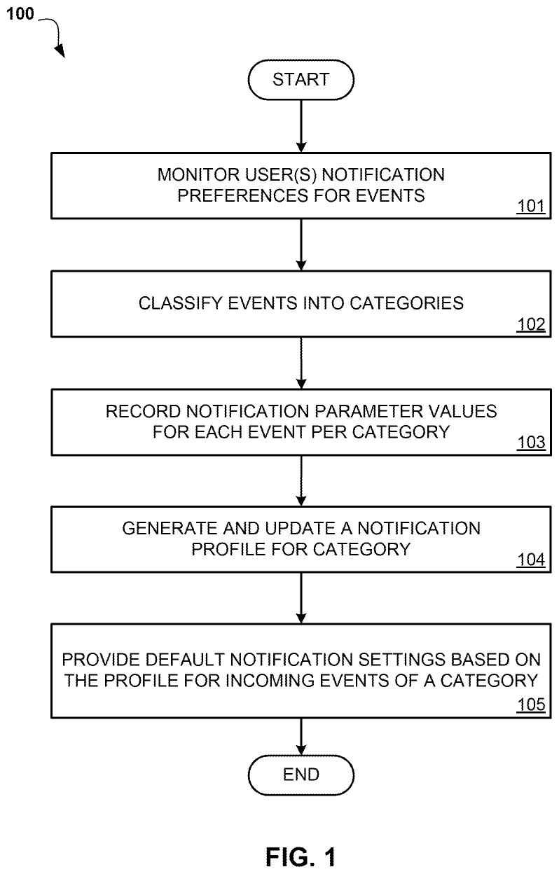

Referring to FIG. 1, a flow diagram 100 shows an example embodiment of an aspect of the described method of building a notification profile.

At 101, the method includes monitoring a user's or a group of users' notification preferences for events of calendar entries. This may monitor a single user's calendar application to determine their preferences for notification settings. In other embodiments, this may monitor a group of users, for example, in an organization or team, to determine their preferences for notification settings. In another embodiment, preferences of co-invitees to an event may also be monitored, based on access permissions. The calendar entries may be incoming calendar entries from another user or may be created calendar entries of the user to which other users may be invited.

The monitoring may monitor a record of past calendar entries and/or may monitor calendar event entries as they arrive to evaluate notification parameters. In one embodiment, an initial evaluation may be carried out based on past calendar entries, for example, for a defined past period of time or from the start of a use of a calendar application. This initial evaluation may be updated as new calendar entries occur. In another embodiment, the monitoring may be in real time and may build the evaluation as the calendar is used without an initial evaluation period.

At 102, events of calendar entries may be classified into event categories. This may be based on text analysis of an event name. New event categories may be added when an event does not fit into existing categories.

The classification may use a general event classifier that is made available to all users. This may classify events into event categories based on the text of the event name and, optionally, any other text associated with the calendar entry. A general event classifier may be trained based on text of events from multiple users.

In another embodiment, the classification may be trained for a specific user or group of users for which the notification profile is generated. The classification training may be carried out when activating a notification profile for a user or group of users. The classification may be trained by the user(s) who may generate event categories and flag events for event categories from a training set of events. Incoming events may then be automatically classified by text similarity to the flagged events.

At 103, a record is generated of values of notification parameters that were used for each event of the monitored events per event category. The record may include the values used for events of previous calendar entries and may be updated for incoming calendar event entries.

The record may include weightings applied to notification parameter values depending on the source or origin of the values. For example, values from other users in a group of users for which the notification profile is generated and applied may have a first defined weighting. In another example, values obtained with access permissions from event inviters or invitees for events may have a second defined weighting applied to notification parameter values. Increased weightings may be applied if a user falls in both categories.

User preferences may be recorded by previous settings of users who are linked to the active users for event categories and not to an actual calendar entry. User preferences for an event of the event inviters or invitees, who may be from a different organization or team, may be recorded for an event.

At 104, a notification profile is generated for each event category with a preference set for each notification parameter based on the recorded notification parameters. This may include dynamically updating the notification parameters of the notification profile as additional calendar entries occur. The notification parameters of the notification parameter may be based on a statistical average of the recorded values, for example, a mode, mean or median of the values. In another embodiment, a most recently recorded value may be used, which may accommodate a user overriding a previous profile parameter.

At 105, the method may provide default notification settings based on the notification profile for incoming events that are matched to an event category. This may include matching an incoming event to an event category, for example, based on the event text and using the same event classifier or using a manual matching by the user. The notification profile for the matched event category may be applied as default notification settings. The default notification settings may have override options for adjustment by the user and such override adjustments may be used as feedback to update the recorded notification parameter values.

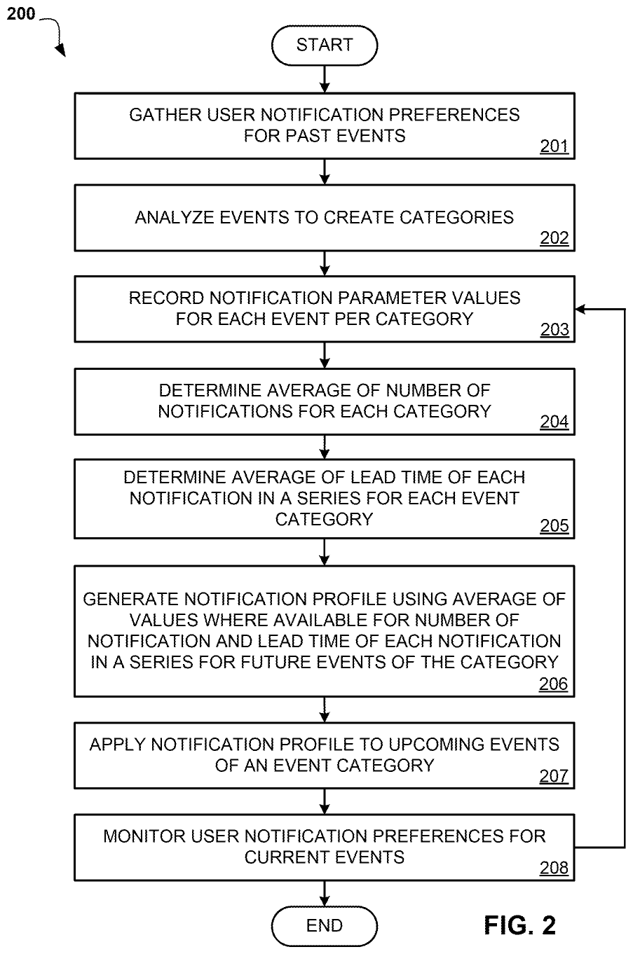

Referring to FIG. 2, a flow diagram 200 shows another example embodiment of an aspect of the described method of building a notification profile.

At 201, the method may gather a user's notification preferences for events of calendar entries for a past time period, for example, for the past year. At 202, the method may analyze the events to create event categories.

Notification parameter values of the gathered preferences for events may be recorded for each event in a category. The notification parameter may include a number of notifications for an event of the event category, and a lead time of each notification in a series of notifications for an event of the event category.

At 204, the mode or other statistical average of each number of notifications may be determined from the recorded notification parameter values. At 205, the mode or other statistical average of each lead time of each notification in a series may also be determined from the recorded notification parameter values.

At 206, notification profile may be generated with the parameter values defined as the determined modes or other statistical average. For example, the defined number of notifications may be the mode number of notifications and a defined lead time of each notification in a series of notifications may be the mode lead time of the notifications in the series. If a mode or other statistical average has not been determined for a parameter, for example, if there are insufficient values or if each value is different in the case of the mode, then a default parameter value may be used.

At 207, the method may apply the notification profile to subsequent events of an event category. Applying a notification profile of notification parameters to an event includes matching the event to an event category and applying the notification profile of the matched event category.

At 208, the method may monitor user-overriding of applied notification parameters. For example, there may be an option to confirm or change an automated notification parameter. The method may update the record 203 of notification parameter values if a new or overriding notification parameter value is used in order to determine new mode values at 204, 205 and update the generated notification profile at 206.

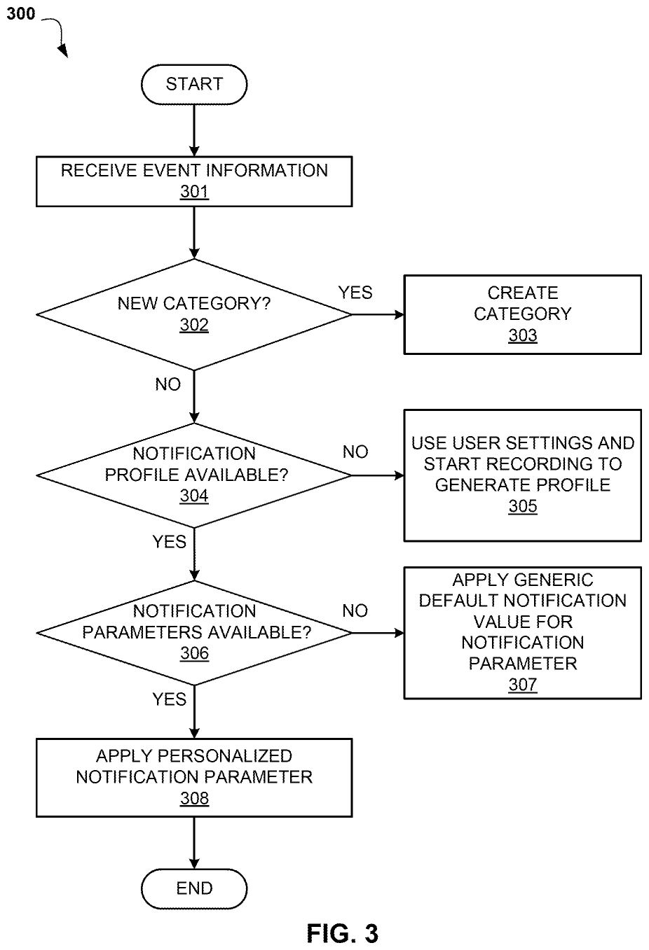

Referring to FIG. 3, a flow diagram 300 shows an example embodiment of an aspect of the described method of applying a notification profile at event creation in a calendar application.

At 301, the method may receive event information entered by a user when making a calendar entry. At 302, the method may determine if the new event can be classified into a suitable existing event category or if a new event category is required.

If a new category is required, a category is created at 303 for the event. As there is no existing notification profile for this new category, user notification settings are used for the new event according to a conventional method. Once a sufficient number of events have been classified in the event category, an event category notification profile may be generated as described in the methods of FIGS. 1 and 2.

If a suitable event category exists, the method may determine at 304 if a notification profile exists for the event category. If there is no existing notification profile, user settings may be applied at 305 and recorded to start generating a notification profile for the event category.

If a notification profile exists, the method may determine at 306 if each notification parameter of the notification profile is available. If a notification parameter is not available, a generic default notification parameter value may be applied at 307. If the notification parameter is available, the personalized notification parameter is applied at 308.

An example is shown below of how the learning process captures delivered notifications. Table 1 shows a table structure capturing and recording the raw notification setting data. Table 1 has provision for a single notification or a series of two notifications and timings of the notifications.

TABLE 1

| | | Final | Final |
|---|---|---|---|
| Entry ID | Category | Notification | Notification − 1 |
| 001 | Weekend away | 1 day | 1 week |
| 002 | Evening out | 2 hours | |
| 003 | Family day out | 2 hours | |
| 004 | Regular sports lesson | 3 hours | |
| 005 | Evening out | 1 day | |
| 006 | Medical appointment | 1 hour | 1 day |
| 007 | Medical appointment | 2 hours | 1 day |
| 008 | Weekend away | 1 day | 1 week |
| 009 | Evening out | 1 hour | |
| 010 | Regular sports lesson | 3 hours | |

Table 1 may be expanded to identify where the recorded value has originated, for example, from another user in a group of users for which the profile is generated, or from an inviter or invitee of the event.

Table 2 shows the raw data being used to calculate mode values where possible for each notification parameter for each category. Table 2 may be expanded to include a weighting for the values in the calculations based on the origin of the recorded values.

TABLE 2

| | Mode | Mode |
|---|---|---|
| Category | Final Notification | Final Notification − 1 |
| Weekend away | 1 day | 1 week |
| Evening out | Default | None |
| Family day out | 2 hours | None |
| Regular sports lesson | 3 hours | None |
| Medical appointment | Default | 1 day |

It can be seen that an event category of “Weekend away” has two logged entries in the raw data, both with the same settings of a series of two notification—one a week before and one a day before the event. Therefore this gives a mode of these settings which are applied to the category in Table 2.

In the event category of “Evening out”, there are three logged entries in the raw data. They each only use one notification but they each have a different value—2 hours, 1 day, 1 hour. So there is a mode of no second notification, but the timing of the first notification does not have a mode value and therefore a default value is applied.

In the event category of “Family day out”, there is only one logged entry in the raw data. This is a single notification of 2 hours. Therefore, this is used in the notification profile shown in Table 2.

In the event category of “Regular sports lesson”, there are two logged entries in the raw data both using one notification of the same time of 3 hours. Therefore, this is used in the notification profile shown in Table 2.

In the event category of “Medical appointment”, there are two logged entries in the raw data both using two notifications. The first notification has the same timing of 1 day, but the second notification has different timings of 1 hour and 2 hours. Therefore, two notifications are used in the profile with the first notification being 1 day, and the second notification using a default.

It can be seen that the more raw data that are available will increase the availability of a profile parameter setting and will improve the likelihood of the setting being acceptable to the user.

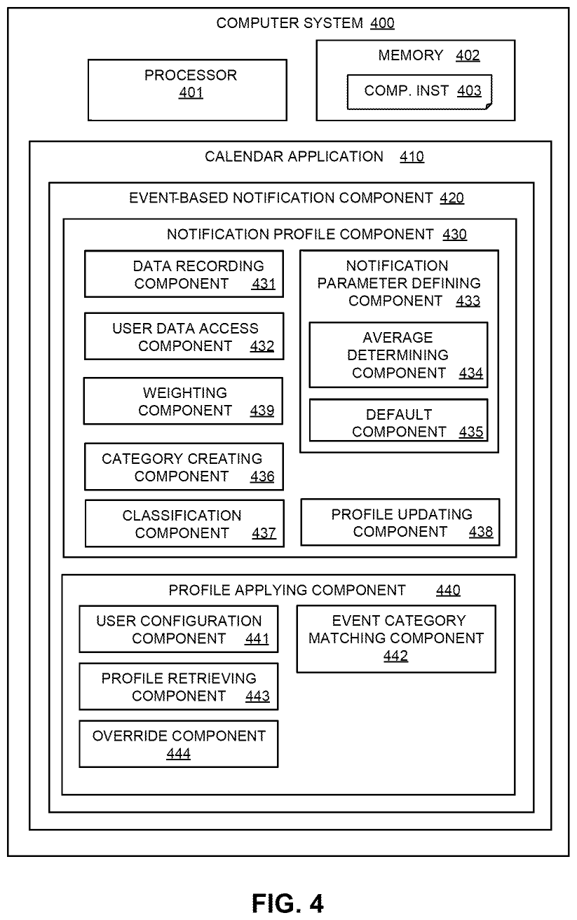

Referring to FIG. 4, a block diagram shows a computer system 400 in which the described system may be implemented as an event-based notification component 420 in a calendar application 410.

The computer system 400 may include at least one processor 401, a hardware module, or a circuit for executing the functions of the described components which may be software units executing on the at least one processor. Multiple processors running parallel processing threads may be provided enabling parallel processing of some or all of the functions of the components. Memory 402 may be configured to provide computer instructions 403 to the at least one processor 401 to carry out the functionality of the components.

The event-based notification component 420 may include a notification profile component 430 for generating a notification profile for event categories based on notification parameters used for events in the event category of previous calendar entries.

The event-based notification component 420 may also include a profile applying component 440 for applying a notification profile of notification parameters to an event of a new calendar entry by matching the event to an event category and applying the notification profile of the matched event category.

The notification profile component 430 may include a data recording component 431 for compiling setting data of past events. The notification profile component 430 may include a classification component 437 for classifying events into event categories. This may access a remote classifier or may train a classifier based on inputs by the user or group of users. The notification profile component 430 may include a category creating component 436 for creating a new event category for events.

The notification profile component 430 may also include a user data access component 432 for providing access to other users' data for additionally compiling setting data of other users on which to base notification profiles. The user data access component 432 may allow the generation of a notification profile based on notification parameters used for events in the event category of previous calendar entries of event invitees. The notification profile component 430 may include a weighting component 439 for applying weightings to other users' parameter values.

The notification profile component 430 may include a notification parameter defining component 433 for defining notification parameters in a parameter profile for an event category. As an example, there may be a notification parameter of a number of notifications for an event of the event category and/or notification parameters of a lead time of each notification in a series of notifications for an event of the event category. In one embodiment, the notification parameter defining component 433 may include an average determining component 434 for defining the notification parameters based on a statistical average of the parameters in the recorded settings data. The notification parameter defining component 433 may include a default component 435 for providing a default notification parameter setting if a mode value is not available.

The notification profile component 430 may include a profile updating component 438 for dynamically updating the notification parameters of the notification profile of an event category as additional calendar entries occur. This may include updating the recorded data as new entries occur.

The profile applying component 440 may include a user configuration component 441 for configuring users of the notification profile. For example, a profile may be available for use by other users in an organization or team.

The profile applying component 440 may include an event category matching component 442 for matching a new event to an existing event category and a profile retrieving component 443 for retrieving a notification profile for the event category. The profile applying component 440 may include an override component 444 for overriding a notification parameter of the notification profile by the user.

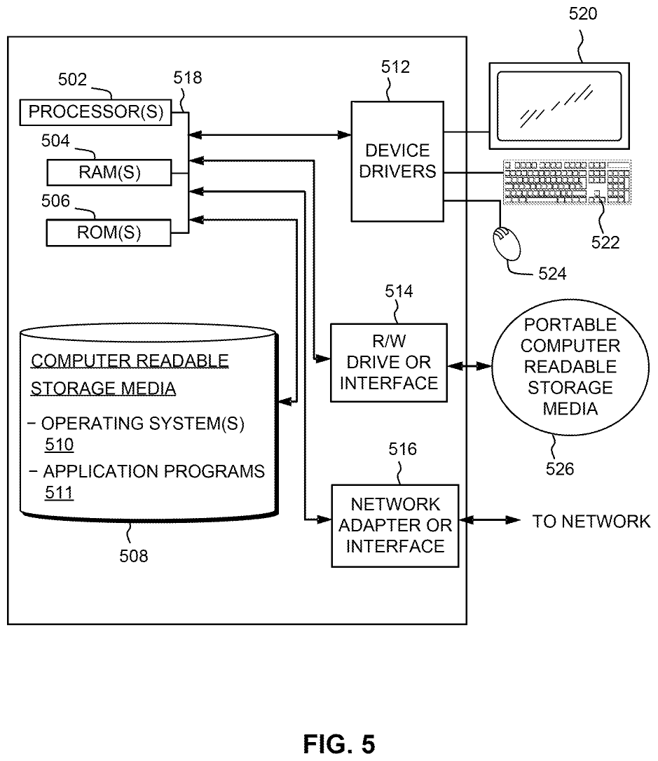

FIG. 5 depicts a block diagram of components of a computing system 400 in accordance with an embodiment of the present invention. It should be appreciated that FIG. 5 provides only an illustration of one implementation and does not imply any limitations with regard to the environments in which different embodiments may be implemented. Many modifications to the depicted environment may be made.

The computing system can include one or more processors 502, one or more computer-readable RAMs 504, one or more computer-readable ROMs 506, one or more computer readable storage media 508, device drivers 512, read/write drive or interface 514, and network adapter or interface 516, all interconnected over a communications fabric 518. Communications fabric 518 can be implemented with any architecture designed for passing data and/or control information between processors (such as microprocessors, communications and network processors, etc.), system memory, peripheral devices, and any other hardware components within the system.

One or more operating systems 510, and application programs 511, such as an event-based notification component 420 are stored on one or more of the computer readable storage media 508 for execution by one or more of the processors 502 via one or more of the respective RAMs 504 (which typically include cache memory). In the illustrated embodiment, each of the computer readable storage media 508 can be a magnetic disk storage device of an internal hard drive, CD-ROM, DVD, memory stick, magnetic tape, magnetic disk, optical disk, a semiconductor storage device such as RAM, ROM, EPROM, flash memory, or any other computer readable storage media that can store a computer program and digital information, in accordance with embodiments of the invention.

The computing system can also include a R/W drive or interface 514 to read from and write to one or more portable computer readable storage media 526. Application programs 511 on the computing system can be stored on one or more of the portable computer readable storage media 526, read via the respective R/W drive or interface 514 and loaded into the respective computer readable storage media 508.

The computing system can also include a network adapter or interface 516, such as a TCP/IP adapter card or wireless communication adapter. Application programs 511 on the computing system can be downloaded to the computing device from an external computer or external storage device via a network (for example, the Internet, a local area network or other wide area networks or wireless networks) and network adapter or interface 516. From the network adapter or interface 516, the programs may be loaded into the computer readable storage media 508. The network may comprise copper wires, optical fibers, wireless transmission, routers, firewalls, switches, gateway computers and edge servers.

The computing system can also include a display screen 520, a keyboard or keypad 522, and a computer mouse or touchpad 524. Device drivers 512 interface to display screen 520 for imaging, to keyboard or keypad 522, to computer mouse or touchpad 524, and/or to display screen 520 for pressure sensing of alphanumeric character entry and user selections. The device drivers 512, R/W drive or interface 514, and network adapter or interface 516 can comprise hardware and software stored in computer readable storage media 508 and/or ROM 506.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Cloud Computing

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

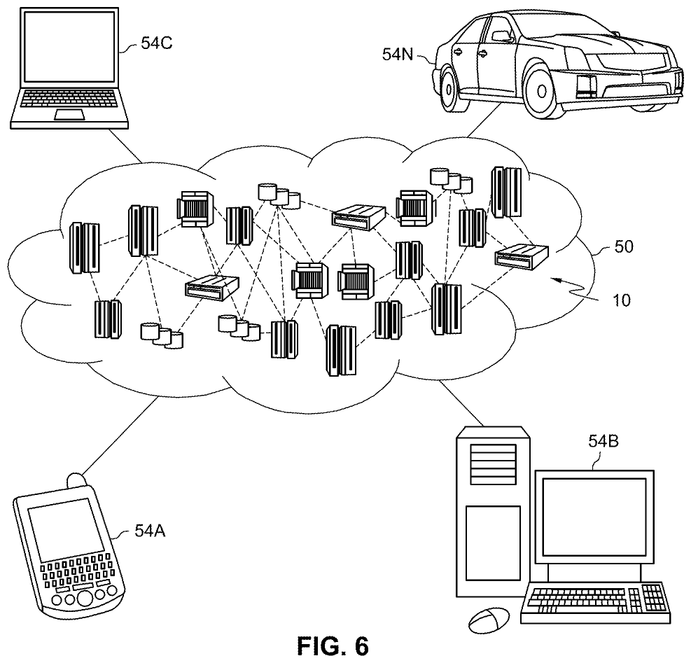

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

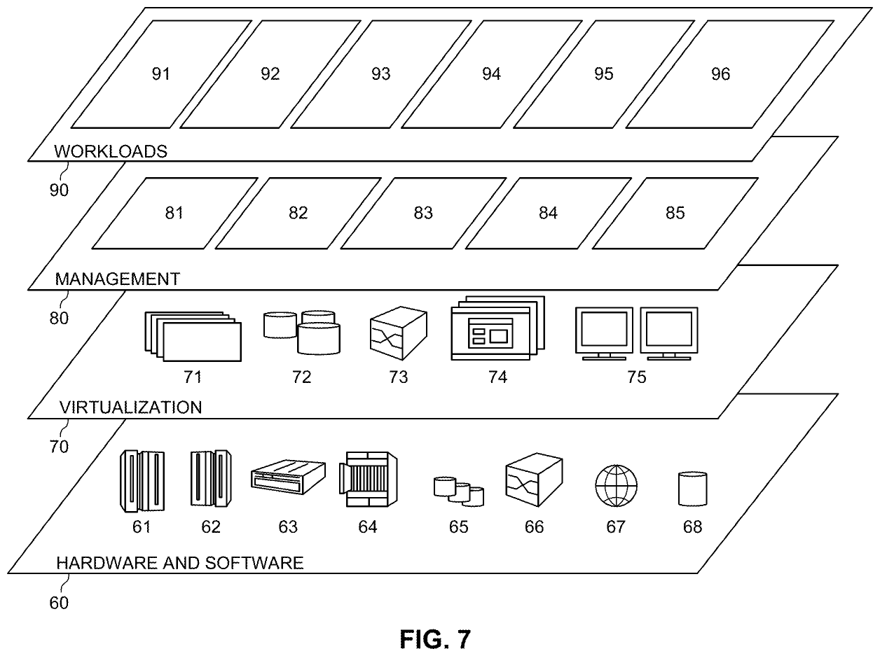

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and event notification processing 96.

A computer program product of the present invention comprises one or more computer readable hardware storage devices having computer readable program code stored therein, said program code executable by one or more processors to implement the methods of the present invention.

A computer system of the present invention comprises one or more processors, one or more memories, and one or more computer readable hardware storage devices, said one or more hardware storage device containing program code executable by the one or more processors via the one or more memories to implement the methods of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

What is claimed is:

1. A computer-implemented method for event-based calendar entry notifications, comprising:
providing a plurality of event categories for classifying at least one event of a calendar entry;
generating a notification profile for each of the plurality of event categories based on a notification parameter used in a previous calendar entry; and
applying the notification profile to an event of a new calendar entry by matching the event category of the event of the new calendar entry to an event category and using the notification profile applied to the event category.

2. The computer-implemented method of claim 1, wherein generating the notification profile for each of the plurality of event categories includes dynamically updating the notification parameter as at least one additional calendar entry occurs.

3. The computer-implemented method of claim 1, wherein generating the notification profile for each of the plurality of event categories includes applying a generic default notification setting to the notification parameter where the notification parameter of at least one previous calendar entry is not available.

4. The computer-implemented method of claim 1, wherein generating the notification profile for each of the plurality of event categories includes defining the notification parameters for an event of the event category, wherein the notification parameters are selected from a group comprising: a number of notifications and a lead time of each notification in a series of notifications.

5. The computer-implemented method of claim 4, wherein defining the notification parameter further comprises calculating a statistical average of values of the notification parameter used in the plurality of event categories in at least one previous calendar entry.

6. The computer-implemented method of claim 1, further comprising: classifying events into the plurality of event categories based on text in the calendar entry for the event based on trained event classification.

7. The computer-implemented method of claim 1, further comprising: creating a new event category if it is determined that the event of a new calendar entry does not include an existing event category.

8. The computer-implemented method of claim 1, wherein generating the notification profile for each of the plurality of event categories further comprises: identifying a user and generating a notification profile based on a previous calendar entry of the user.

9. The computer-implemented method of claim 1, wherein generating the notification profile for each of the plurality of event categories is based on the notification parameter of an event in the event category of at least one previous calendar entry.

10. The computer-implemented method of claim 1, wherein generating the notification profile further comprises:
determining an origin of the notification parameter of previous calendar entries; and
applying a weighting based on the origin of the notification parameter.

11. A computer system for event-based calendar entry notifications, comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
providing a plurality of event categories for classifying at least one event of a calendar entry;
generating a notification profile for each of the plurality of event categories based on a notification parameter used in a previous calendar entry; and
applying the notification profile to an event of a new calendar entry by matching the event category of the event of the new calendar entry to an event category and using the notification profile applied to the event category.

12. The computer system of claim 11, wherein generating the notification profile for each of the plurality of event categories includes dynamically updating the notification parameter as at least one additional calendar entry occurs.

13. The computer system of claim 11, wherein generating the notification profile for each of the plurality of event categories includes applying a generic default notification setting to the notification parameter where the notification parameter of at least one previous calendar entry is not available.

14. The computer system of claim 11, wherein generating the notification profile for each of the plurality of event categories includes defining the notification parameters for an event of the event category, wherein the notification parameters are selected from a group comprising: a number of notifications and a lead time of each notification in a series of notifications.

15. The computer system of claim 14, wherein defining the notification parameter further comprises calculating a statistical average of values of the notification parameter used in the plurality of event categories in at least one previous calendar entry.

16. The computer system of claim 11, further comprising: creating a new event category if it is determined that the event of a new calendar entry does not include an existing event category.

17. The computer system of claim 11, further comprising: classifying events into the plurality of event categories based on text in the calendar entry for the event based on trained event classification.

18. The computer system of claim 11, further comprising: configuring access to the previous calendar entry based on the notification profile.

19. The computer system of claim 18, wherein generating the notification profile for each of the plurality of event categories is based on the notification parameter of an event in the event category of at least one previous calendar entry.

20. A computer program product for event-based calendar entry notifications, the computer program product comprising a computer readable storage medium having program instructions embodied therewith, the program instructions executable by a processor to cause the processor to:
provide a plurality of event categories for classifying at least one event of a calendar entry;
generate a notification profile for each of the plurality of event categories based on a notification parameter used in a previous calendar entry; and
apply the notification profile to an event of a new calendar entry by matching the event category of the event of the new calendar entry to an event category and using the notification profile applied to the event category.
